(19) United States
(12) Patent Application Publication
(10) Pub. No.: US 2005/0126646 A1
(43) Pub. Date: Jun. 16, 2005

(54) Flow rate adjusting device

(76) Inventor: Willi Hempelmann, Olpe (DE)

Correspondence Address: BURNS DOANE SWECKER & MATHIS L L P, POST OFFICE BOX 1404, ALEXANDRIA, VA, 22313-1404, US

(21) Appl. No.: 10/489,805

(22) PCT Filed: Sep. 20, 2002
(86) PCT No.: PCT/EP02/10590

(30) Foreign Application Priority Data
Sep. 21, 2001 (DE) 101 46 625.0

(51) Int. Cl. F17D 3/00

(52) U.S. Cl. 137/624.11

(57) ABSTRACT

The invention relates to a flow control device which comprises at least two control disks which are arranged coaxially with respect to one another, lie tightly against one another and can rotate relative to one another about their common axis, the control disks having a through-bore arranged eccentrically and leading through in the axial direction, and, on the side faces lying against one another, in each case a recess which, starting from the through-bore, extends along an arc of a circle about the axis of the control disks, so that if there is relative rotation, only parts of the opposite recesses overlap.

The invention relates to a flow control device, in particular for liquids.

The object of the invention is to design a flow control device in such a way that the flow path and also the flow rates can be adjusted.

According to the invention, this object is achieved by the features in claim 1. By virtue of the fact that the recesses extending laterally from the through-bores in the adjacent side faces of the disks, which can rotate relative to one another, are able to overlap to different extents, it is possible, for example, starting from a maximum flow rate with the through-bores flush, to adjust to very low flow rates as a result of the terminal points of the tapering recesses overlapping slightly. In this way, flow rates can be adjusted steplessly to the range of microliters to nanoliters.

Illustrative embodiments of the invention are explained in more detail below with reference to the drawing, in which:

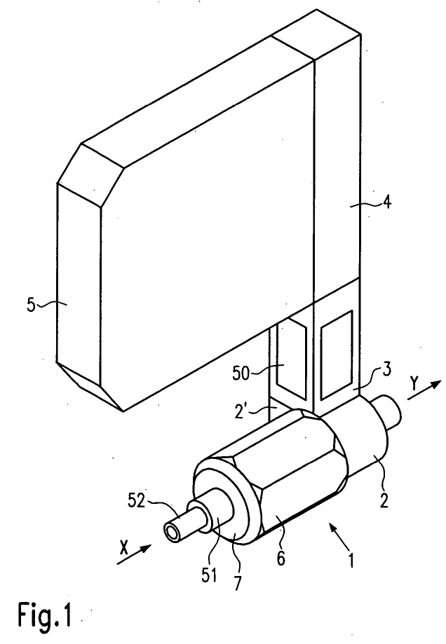

FIG. 1 shows a perspective view of a flow control device with control unit,

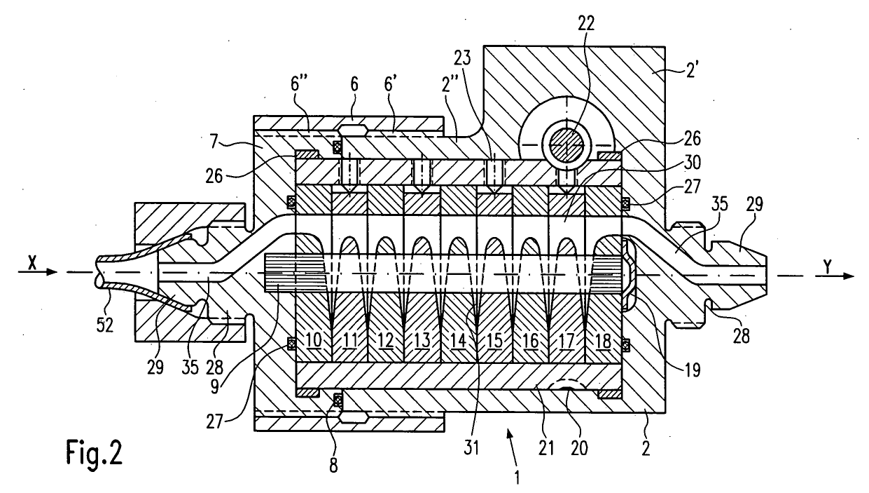

FIG. 2 shows a diagrammatic longitudinal section through an embodiment of the flow control device with a plurality of control disks,

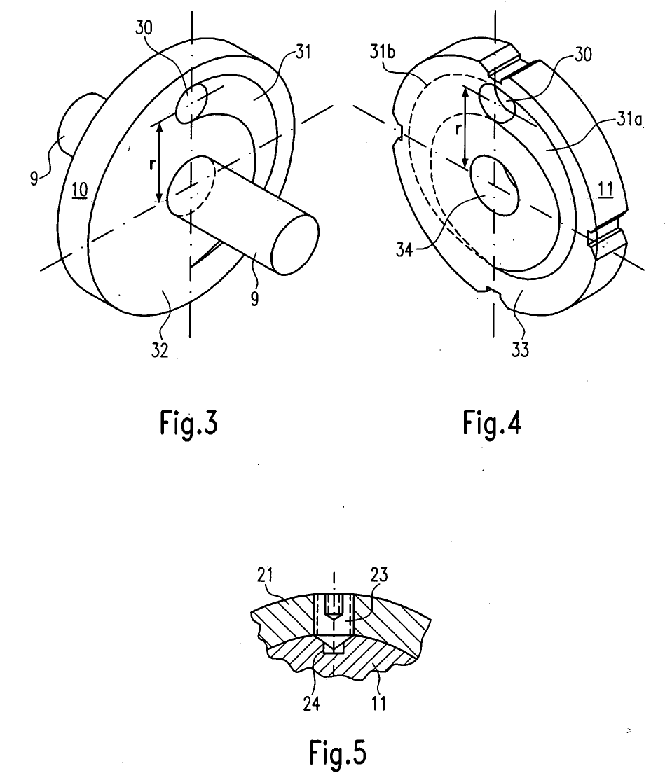

FIG. 3 shows a perspective view of a stationary control disk,

FIG. 4 shows a perspective view of a rotatable control disk,

FIG. 5 shows the securing of a rotatable control disk on a wormwheel,

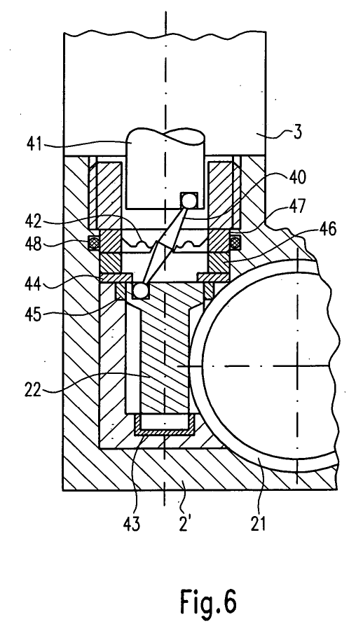

FIG. 6 shows a sectional view through a drive means of the wormwheel, and

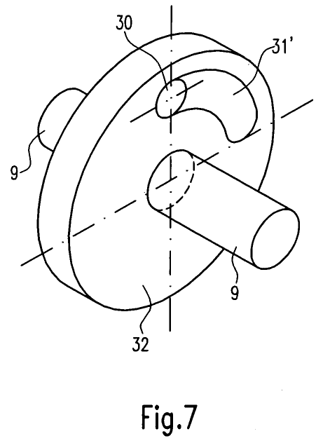

FIG. 7 shows a modified embodiment of a control disk.

In FIG. 1, reference number 1 indicates the flow control device through which a liquid flows in the axial direction, indicated by the arrows X and Y. Arranged on the housing 2 of the flow control device, via an attachment 2′, there is a coupling and sealing adapter 3 on which a motor housing 4 is secured, in which for example a direct-current motor or a linear motor is arranged. A control unit 5 with electronic control means is arranged on the motor housing 4.

FIG. 2 shows diagrammatically a longitudinal section through the flow control device 1. A screw-on sleeve 6 with a threaded portion 6′ is screwed onto the tubular section 2″ of the housing 2, which screw-on sleeve 6, together with a separately formed threaded portion 6″, holds a housing part 7 bearing on the tubular housing section 2″. Reference number 8 indicates a seal, for example an O-ring between the two housing parts 2 and 7. The threaded portion 6′ is for example designed as a right-hand thread, while the threaded portion 6″ is designed as a left-hand thread. In this way, the two housing parts 2 and 7 can be fixed by the screw-on sleeve 6 so as to bear tightly on one another.

Inserted into a central bore of the housing part 7 there is a fixed plug-in shaft 9 which, on the circumference, has a serrated profile or a toothing which engages with a corresponding serrated profile in the housing bore. In the illustrative embodiment shown, nine control disks 10 to 18 are arranged on this plug-in shaft 9. The first control disk 10 and the control disk 18 at the opposite end are fixed in a stationary position on the plug-in shaft 9 via the serrated profile, and likewise the control disks 12, 14 and 16, whereas the intermediate control disks 11, 13, 15 and 17 are rotatable on the plug-in shaft 9 as a result of a greater diameter of the bore. The control disks 10 to 18 are held lying tightly against one another by means of the pretensioning of a cup spring 19 which is arranged in a recess of the housing 2. The control disks 10 to 18 are surrounded by a sleeve-shaped wormwheel 21 which can be set in rotation by a worm shaft 22 which, as is shown in FIG. 6, is rotated by the drive motor arranged in the motor housing 4. The rotatable control disks 11, 13, 15 and 17 are each connected to the wormwheel 21, whereas the stationary control disks 10, 12, 14, 16 and 18 can slide on the inner circumference of the sleeve-shaped wormwheel 21 or can also have an external diameter smaller than the internal diameter of the sleeve-shaped wormwheel 21. In the illustrative embodiment shown, the rotatable control disks are connected to the wormwheel 21 free from play via a centering grub screw 23, as is shown in FIG. 5. Here, for example, four wedge-shaped carrier grooves 24 are formed on the outer circumference of a rotatable control disk (FIG. 4), into which grooves 24 the wedge-shaped point of the centering grub screw 23 engages. These centering grub screws are provided with a hexagon socket, as is indicated in FIG. 5.

In the area of the control disk 17, the sleeve-shaped wormwheel 21 has, on the outer circumference, a worm thread 20 which engages with the thread of a worm shaft 22. The sleeve-shaped wormwheel 21 is mounted rotatably in both housing parts 2 and 7 via slide bearings 26 at the opposite ends.

A seal 27 is provided in each case on the end faces of the two housing parts 2 and 7 and bears on the side faces of the stationary disks 10 and 18. Both housing parts 2 and 7 are each provided with an attachment piece 28 with external thread and a flanged cone 29 for flanged screwing-on of an attachment hose 52. The hose 52 or a bundle-tube is connected in a sealed manner to the attachment piece 28 via a rivet nut 51.

The control disks 10 to 18 are each provided with a through-bore 30 which is arranged eccentrically on the individual control disks in the axial direction, as FIGS. 3 and 4 show. Arranged on the stationary control disk 10, on one side face 32 of the control disk, there is a recess 31 which, starting from the through-bore 30, arranged at a distance r from the axis, tapers off in width and depth and extends in an arc of a circle about the axis at the distance r from said axis. In the illustrative embodiment shown in FIG. 3, this tapering recess 31 extends almost in a semicircle about the axis on the side face 32. The opposite side face of the control disk 10 is smooth and is provided only with the through-bore 30.

FIG. 4 shows a rotatable control disk, for example the control disk 11. Formed on the side face 33 of the rotatable control disk 11 lying opposite the side face 32 of the stationary control disk 10, there is a recess 31a which tapers off starting from the through-bore 30 almost about a semicircle and is identical in design to the recess 31 on the control disk 10, but extends in the opposite direction. While the recess 31 on the control disk 10 extends in the clockwise direction starting from the through-bore 30, the recess 31a on the opposite side face 33 of the control disk 11 extends in the opposite direction so that, upon alignment of the through-bores 30, the one recess 31a extends in the clockwise direction and the recess 31 on the opposite control disk extends in the anticlockwise direction about the axis. By rotating the control disk 11 relative to the control disk 10, the passage cross section can be decreased continuously along the recesses 31 and 31a until only the terminal points of the two recesses 31 and 31a overlap slightly, so that only a minimal passage cross section remains.

On the side face opposite from the side 33, the rotatable control disk 11 has a corresponding recess 31b which starts from the through-bore 30, as shown by broken lines in FIG. 4. The recess 31b extends in the opposite direction to that on the side face 33 and in the same direction as the recess 31 on the control disk 10.

Correspondingly, the stationary control disk 12 is designed with a recess 31a and 31b tapering along an arc of a circle on both side faces. In terms of the arrangement and design of the recesses 31a and 31b, the control disks 11 to 17 are of identical design, the respective recesses tapering off continuously in width and depth along the arc of a circle. The stationary control disk 18 at the opposite end has a mirror-inverted design in relation to the control disk 10, with a recess 31 on only one side face.

In FIG. 2, the through-bores 30 of all the control disks 10 to 18 are represented in a flush position, so that there is a through-channel with a minimal diameter corresponding to that of the bores 30. A passage channel 35 starting from the attachment piece 28 extends in a curved configuration through the housing parts 2 and 7 in such a way that it is flush with the eccentric through-bore 30 of the control disks 10 and 18. In one illustrative embodiment, the internal diameter of the passage channel 35 and the internal diameter of the through-bores 30 can be 5 mm, for example, the recesses 31 tapering off continuously in width and depth to zero starting from the through-bores 30.

The rotatable control disks 11, 13, 15 and 17 are rotated in synchrony relative to the stationary control disks 10, 12, 14, 16 and 18 by the wormwheel 21, so that, between the side faces of the individual control disks lying against one another, the same passage cross section corresponding to the overlapping of the recesses 31, 31a, 31b etc. occurs.

By means of this succession of reduced passage cross sections corresponding to throttle positions, a high pressure of the liquid entering at the inlet side at X can be reduced in steps at the individual throttle positions as far as the outlet at Y. By means of the throttle positions arranged one behind the other, differential pressures of 2 to 300 bar can be reduced in steps, and very low flow rates in the range of microliters and nanoliters are also possible.

When the control disks are rotated relative to one another from the view in FIG. 2, so that throttle positions are formed by cross-sectional reduction at the overlapping recesses 31, 31a, 31b, etc., channel portions of enlarged cross section form between the individual throttle positions because the liquid leaving one throttle position flows through the full cross section of a through-bore 30 before it comes to the next throttle position. In this way, a staged throttle is obtained, with expansion between the throttle positions, for pressure reduction.

Such a flow control device can be used in biotechnology, in fine chemistry and in various fields of application.

Instead of the nine control disks provided in the illustrative embodiment shown, a smaller number of control disks or a larger number can also be provided. For example, it is also possible to provide just one rotatable control disk between the stationary control disks 10 and 18.

The control disks can be made of ceramic material or else of a synthetic such as Teflon, the side faces which lie against one another being made smooth so that they lie tightly against one another under the pretensioning of the cup spring 19. Moreover, pressure compensation channels (not shown) can be provided on the individual control disks in order to compensate for the pressure acting in the axial direction of the flow control device.

The central bore 34 on the rotatable control disks 11, 13, 15 and 17 has a diameter which is equal to or slightly greater than the external diameter of the toothing on the plug-in shaft 9, so that these rotatable control disks can be easily rotated on the plug-in shaft. By means of the wedge-shaped carrier grooves 24, a clearance-free adjustment of the rotatable control disks is possible with the wormwheel 21 via the centering grub screws 23.

In the orientation of the through-bores 30 corresponding to the representation in FIG. 2, that is with a continuously full cross section, a washing liquid can flow through the device, it being also possible for a ball to be passed through the flow control device in order to clean the passage channels.

FIG. 6 shows diagrammatically an example of a means for driving the wormwheel 21 via the worm 22, which is mounted rotatably in the attachment 2′ of the housing. In the illustrative embodiment shown, a wobble rod 40 is arranged between the worm 22 and a shaft 41 mounted in the housing attachment 2′, and is guided through a stiff membrane 42 which on the one hand forms an articulation point for the wobble rod 40 and on the other hand seals the housing off from the drive unit.

Reference number 43 indicates a radial slide bearing for the worm 22 which at the opposite end bears on an axial bearing 44 and is additionally mounted in the housing via a radial bearing 45. Reference number 46 indicates a spacer ring between the axial bearing 44 and a ring 47 which holds the membrane 42 and, on the outer circumference, is sealed off from the housing by a seal, for example an O-ring 48.

A sealing shim (not shown) and a corresponding bearing can be provided on the shaft 41.

As FIG. 1 shows, viewing windows 50 can be provided on the coupling and sealing adapter 3, through which windows 50 the sealing of the flow control device in relation to the drive unit can be monitored.

The flow control device described forms a micro-dosing fixture by means of which it is also possible to control very low flow rates.

According to a further embodiment of the invention, the lateral recesses 31 can, depending on the field of application of the flow control device, also have a shape other than that shown in which the width and depth of the recess 31 taper to zero starting from the through-bore 30. Thus, for example, in the overlapping state, the recesses can form a flow cross section which corresponds to that of the through-bores 30, so that by rotating the control disks relative to one another, starting from a position in which the through-bores 30 are flush with one another and form the shortest flow distance through the device, the flow path through the device can be lengthened by means of a channel which extends in the circumferential direction being formed between successive through-bores 30. FIG. 7 shows, corresponding to FIG. 3, a control disk with a recess 31′ which, with the opposite recess, forms a channel whose cross section corresponds to that of the though-bores 30 and which extends over an angle range of about 45°. However, this recess 31′ can also extend over a greater angle range.

Moreover, in an embodiment of the control disks according to FIG. 7, throttle positions can be formed by means of the opposite recesses 31′ overlapping only at the ends. For this purpose, instead of having the rounded configuration, the ends can also taper to a point. In such an embodiment, the volume between the throttle positions is increased by the extension of the recesses in the circumferential direction toward the through-bore 30.

As has already been stated, this channel extending through the overlapping recesses 31′ in the circumferential direction can have a flow cross section corresponding to that of the through-bores 30, for example for highly viscous fluids such as adhesives and the like. However, it is also possible for these recesses 31′ to be designed tapering over a shorter circumferential section than that shown, so that, when the recesses 31′ overlap, a connection channel tapering in the flow cross section is obtained between the through-bores 30. In such a design, for example, the recess 31 shown in FIG. 3 extends over about a quarter of a circle instead of a semicircle.

In addition, the flow cross section formed by the recesses 31 can also be changed by means of the shape of the recess 31 changing about the circumference, for example by means of the recesses 31 which extend in the circumferential direction having indents, or bulges projecting into the recess, presenting obstacles or cross-sectional changes in the channel formed through the overlapping recesses 31, so that a certain mixing action in the fluid flowing through the device is also produced.

In the flow control device described, the diameter of the through-bores 30 is, for example, 5 mm. However, larger flow cross sections can also be provided in such a flow control device.

1. A flow control device, comprising at least three control disks which are arranged coaxially with respect to one another and lie tightly against one another, from which the control disk lying between stationary control disks can rotate through an actuating device, the control disks having a through-bore arranged eccentrically and leading through in the axial direction, and, on the side faces lying against one another, in each case a recess which, starting from the through-bore extends along an arc of a circle about the axis of the control disks, so that if the control disks rotate relatively toward each other, only parts of the opposite recess overlap.

2. The flow control device as claimed in claim 1, in which the recesses formed on opposite side faces of the control disks extend in the opposite direction in the circumferential direction, starting from the through-bore.

3. The flow control device as claimed in claim 1, in which the width and depth of the recesses taper to approximately zero starting from the through-bore.

4. The flow control device as claimed in claim 1, in which rotatable and stationary control disks are arranged alternately between stationary end disks, and the stationary control disks arranged between the end disks, and the rotatable control disks each have a recess in the form of an arc of a circle on both side faces.

5. The flow control device as claimed in claim 4, in which the stationary control disks are fixed on a shaft passing through them, whereas the rotatable control disks have, on the outer circumference, an engagement means for a rotary drive mechanism.

6. The flow control device as claimed in claim 5, in which the rotatable control disks have, on the outer circumference, wedge-shaped centering grooves into which centering grub screws engage free from play, these being guided through a rotatable sleeve which surrounds the control disks.

7. The flow control device as claimed in claim 6, in which the sleeve on the outer circumference surrounding the control disks is provided with a worm thread with which a worm, set in rotation by a drive motor, is in engagement.

8. The flow control device as claimed in claim 1, in which the control disks are arranged in a two-part housing, both parts of which are clamped together by a screw-on sleeve.

9. The flow control device as claimed in claim 1, in which the control disks are held lying against one another in the axial direction by a spring.
